(19) United States
(12) Patent Application Publication
(10) Pub. No.: US 2016/0203499 A1
(43) Pub. Date: Jul. 14, 2016

(54) CUSTOMER BEHAVIOR ANALYSIS SYSTEM, CUSTOMER BEHAVIOR ANALYSIS METHOD, NON-TRANSITORY COMPUTER READABLE MEDIUM, AND SHELF SYSTEM

(71) Applicant: NEC CORPORATION, Tokyo (JP)

(72) Inventors: Nobuyuki YAMASHITA, Tokyo (JP); Kaoru UCHIDA, Tokyo (JP)

(73) Assignee: NEC Corporation, Tokyo (JP)

(21) Appl. No.: 14/916,705

(22) PCT Filed: Sep. 5, 2014
(86) PCT No.: PCT/JP2014/004585

§ 371 Date: Mar. 4, 2016

(30) Foreign Application Priority Data
Sep. 6, 2013 (JP) 2013-185131

(51) Int. Cl. G06Q 30/02; G06K 9/00

(52) U.S. Cl. CPC G06Q 30/0201; G06K 9/00355; G06K 9/00771

(57) ABSTRACT

A customer behavior analysis system (10) includes an image information acquisition unit (11) that acquires input image information on an image taken of a presentation area where a product is presented to a customer, an action detection unit (12) that detects whether the customer is holding the product and looking at an identification display of the product based on the input image information, and a customer behavior analysis information generation unit (13) that generates customer behavior analysis information containing a relationship between a result of the detection and a purchase result of the product by the customer. This enables to analyze the more detailed behavior of a customer.

### TECHNICAL FIELD

The present invention relates to a customer behavior analysis system, a customer behavior analysis method, a non-transitory computer readable medium storing a customer behavior analysis program, and a shelf system and, particularly, to a customer behavior analysis system, a customer behavior analysis method, a non-transitory computer readable medium storing a customer behavior analysis program, and a shelf system using product and customer images.

### BACKGROUND ART

For effective sales promotions, analysis of customer behavior is carried out in stores and the like where many products are displayed. For example, the behavior of customers is analyzed from the moving history in the store, the purchasing history of products and the like of the customers.

Patent Literature publications 1 to 3, for example, are known as related art.

### CITATION LIST

### Patent Literature

PTL1: Japanese Unexamined Patent Publication No. 2011-253344

PTL2: Japanese Unexamined Patent Publication No. 2012-252613

PTL3: Japanese Unexamined Patent Publication No. 2011-129093

### SUMMARY OF INVENTION

### Technical Problem

For example, when performing behavior analysis using a POS system, information is recorded at the payment for a product, and therefore information about sold products only is acquired. Further, in Patent Literature 1, although information indicating that a customer touches a product is acquired, more detailed behavior of the customer cannot be analyzed.

Thus, the technique disclosed in the related art cannot acquire and analyze detailed information about products not purchased by customers, such as a product which a customer has taken an interest in and picked up but decided not to purchase, and it is thus not possible to take effective measures to promote sales.

Thus, the technique disclosed in the related art has a problem that it is difficult to analyze in more detail the behavior of a customer when a product is not purchased or the like.

In light of the above, an exemplary object of the present invention is to provide a customer behavior analysis system, a customer behavior analysis method, a non-transitory computer readable medium storing a customer behavior analysis program, and a shelf system capable of analyzing the more detailed behavior of a customer.

### Solution to Problem

A customer behavior analysis system according to an exemplary aspect of the present invention includes an image information acquisition unit that acquires input image information on an image taken of a presentation area where a product is presented to a customer, an action detection unit that detects whether the customer is holding the product and looking at an identification display of the product based on the input image information, and a customer behavior analysis information generation unit that generates customer behavior analysis information containing a relationship between a result of the detection and a purchase result of the product by the customer.

A customer behavior analysis method according to an exemplary aspect of the present invention includes acquiring input image information on an image taken of a presentation area where a product is presented to a customer, detecting whether the customer is holding the product and looking at an identification display of the product based on the input image information, and generating customer behavior analysis information containing a relationship between a result of the detection and a purchase history of the product by the customer.

A non-transitory computer readable medium storing a customer behavior analysis program according to an exemplary aspect of the present invention causes a computer to perform a customer behavior analysis process including acquiring input image information on an image taken of a presentation area where a product is presented to a customer, detecting whether the customer is holding the product and looking at an identification display of the product based on the input image information, and generating customer behavior analysis information containing a relationship between a result of the detection and a purchase history of the product by the customer.

A shelf system according to an exemplary aspect of the present invention includes a shelf placed to present a product to a customer, an image information acquisition unit that acquires input image information on an image taken of a presentation area where a product is presented to a customer, an action detection unit that detects whether the customer is holding the product and looking at an identification display of the product based on the input image information, and a customer behavior analysis information generation unit that generates customer behavior analysis information containing a relationship between a result of the detection and a purchase result of the product by the customer.

### Advantageous Effects of Invention

According to the exemplary aspects of the present invention, it is possible to provide a customer behavior analysis system, a customer behavior analysis method, a non-transitory computer readable medium storing a customer behavior analysis program, and a shelf system capable of analyzing the more detailed behavior of a customer.

### BRIEF DESCRIPTION OF DRAWINGS

FIG. 1 is a block diagram showing main elements of a customer behavior analysis system according to an exemplary embodiment;

FIG. 2 is a block diagram showing the configuration of a customer behavior analysis system according to a first exemplary embodiment;

FIG. 3 is a diagram showing a configuration example of a 3D camera according to the first exemplary embodiment;

FIG. 4 is a block diagram showing a configuration of a distance image analysis unit according to the first exemplary embodiment;

FIG. 5 is a flowchart showing the operation of the customer behavior analysis system according to the first exemplary embodiment;

FIG. 6 is a flowchart showing the operation of a distance image analysis process according to the first exemplary embodiment;

FIG. 7 is a diagram showing an example of an action profile according to the first exemplary embodiment;

FIG. 8 is a diagram showing an analysis example of an action profile according to the first exemplary embodiment;

FIG. 9 is a diagram showing an analysis example of an action profile according to the first exemplary embodiment; and

FIG. 10 is a block diagram showing the configuration of a shelf system according to a second exemplary embodiment.

### DESCRIPTION OF EMBODIMENTS

### Overview of Exemplary Embodiment

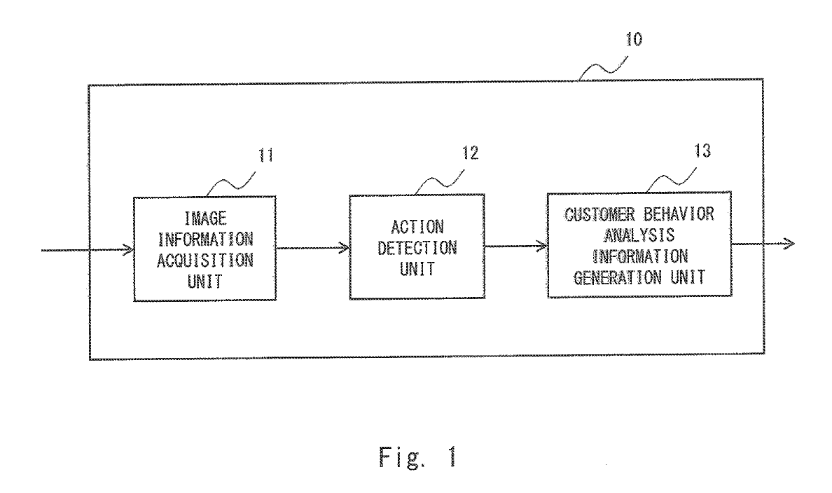

Prior to describing exemplary embodiments, the overview of the characteristics of the exemplary embodiments is described hereinbelow. FIG. 1 shows main elements of a customer behavior analysis system according to an exemplary embodiment.

As shown in FIG. 1, a customer behavior analysis system 10 according to this exemplary embodiment includes an image information acquisition unit 11, an action detection unit 12, and a customer behavior analysis information generation unit 13. The image information acquisition unit 11 acquires input image information, which is an image taken of a presentation area where a product is to be presented to customers. The action detection unit 12 detects whether a customer is holding the product and looking at an identification display of the product based on the input image information. The customer behavior analysis information generation unit 13 generates customer behavior analysis information containing the relationship between a detected result and a product purchasing history of a customer.

As described above, in the exemplary embodiment, it is detected whether a customer is holding the product and looking at an identification display of the product, and the customer behavior analysis information is generated based on a result of the detection. Because it is thereby possible to analyze the relationship between the fact that a customer looks at an identification display such as a label of a product and the purchase of the product, it is possible to grasp the reason why, for example, the customer decides not to purchase the product, which enables a more detailed analysis of the behavior of the customer.

### First Exemplary Embodiment

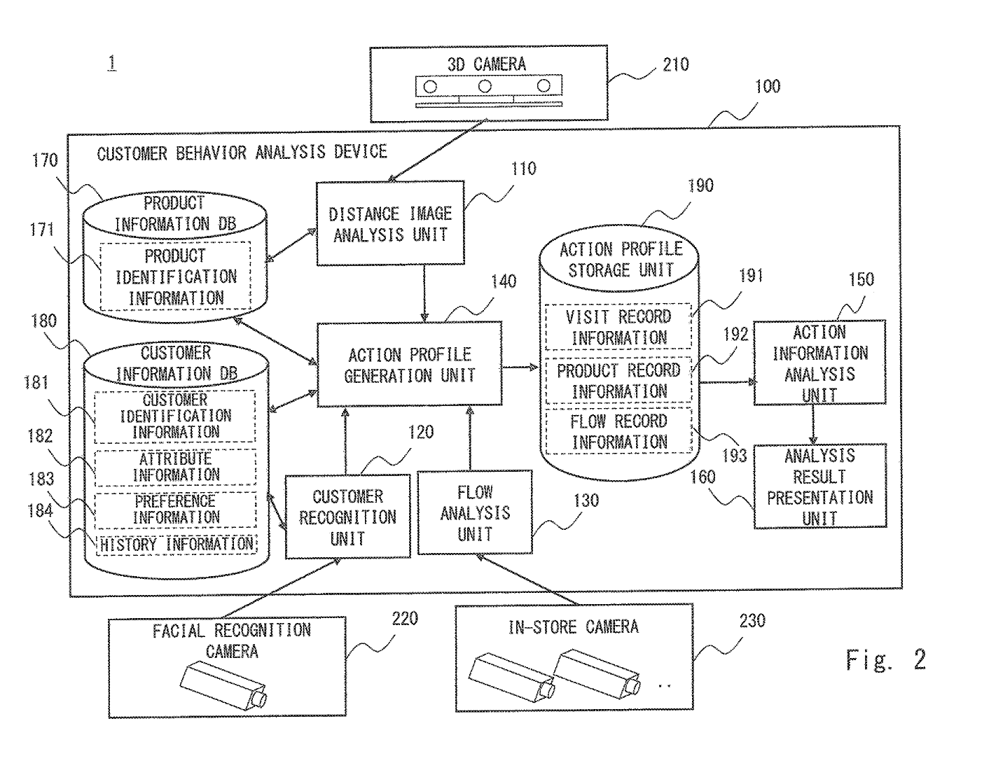

A first exemplary embodiment is described hereinafter with reference to the drawings. FIG. 2 is a block diagram showing the configuration of a customer behavior analysis system according to this exemplary embodiment. This customer behavior analysis system is a system that detects a customer's action (behavior) regarding a product, generates an action profile (customer behavior analysis information) to visualize the detected action and carries out an analysis. Note that the customer includes a person (shopper) who has not yet actually purchased a product (has not yet actually determined to purchase a product), and it includes, for example, an arbitrary person who happens to come to (enter) a store.

As shown in FIG. 2, a customer behavior analysis system 1 according to this exemplary embodiment includes a customer behavior analysis device 100, a 3D camera 210, a facial recognition camera 220, and an in-store camera 230. For example, while the respective components of the customer behavior analysis system 1 are placed in the same store, the customer behavior analysis device 100 may be placed outside the store. Although it is assumed in the following description that the respective components of the customer behavior analysis system 1 are separate devices, the respective components may be one or any number of devices.

The 3D (three-dimensional) camera 210 is an imaging device (distance image sensor) that takes an image of and measures a target and generates a distance image (distance image information). The distance image (range image) contains image information which is an image of a target taken and distance information which is a distance to a target measured. For example, the 3D camera 210 is Microsoft Kinect (registered trademark) or a stereo camera. By using the 3D camera, it is possible to recognize (track) a target (a customer's action or the like) including the distance information, and it is thus possible to perform highly accurate recognition.

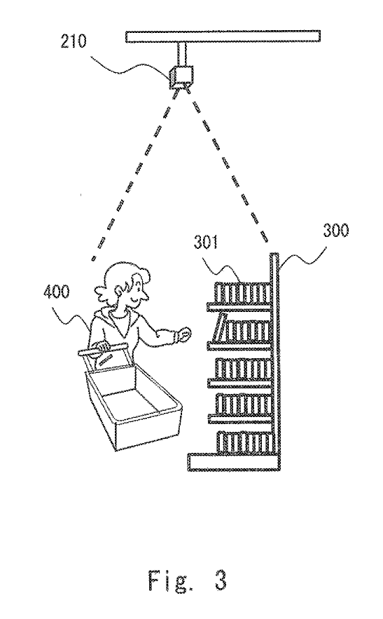

As shown in FIG. 3, in order to detect a customer's action regarding a product, the 3D camera 210 takes an image of a product shelf (product display shelf) 300 on which a product 301 is placed (displayed) and further takes an image of a customer 400 who is thinking about purchasing the product 301 in front of the product shelf 300 in this exemplary embodiment. The 3D camera 210 takes an image of a product placement area of the product shelf 300 and an area where a customer picks up/looks at a product in front of the product shelf 300, which is a presentation area where a product is presented to a customer in the product shelf 300. The 3D camera 210 is placed at a position where images of the product shelf 300 and the customer 400 in front of the product shelf 300 can be taken, which is, for example, above (the ceiling etc.) or in front of (a wall etc.) of the product shelf 300, or in the product shelf 300. Although the product 300 is a real product (commodity, article, item, goods), it is not limited to a real thing and instead may be, for example, a sample or a print on which a label or the like is printed.

Note that, although an example in which the 3D camera 210 is used as a device that takes images of the product shelf 300 and the customer 400 is described below, it is not limited to the 3D camera but may be a general camera (2D camera) that outputs only images taken. In this case, tracking is performed using the image information only.

Each of the facial recognition camera 220 and the in-store camera 230 is an imaging device (2D camera) that takes and generates an image of a target. The facial recognition camera 220 is placed at the entrance of a store or the like, takes an image of a face of a customer who comes to the store and generates a facial image to recognize the customer's face. The in-store camera 230 is placed at a plurality of positions in a store, takes an image of each section in the store and generates an in-store image to detect the customer traffic flow in the store. Note that each of the facial recognition camera 220 and the in-store camera 230 may be a 3D camera. By using a 3D camera, it is possible to accurately recognize the customer's face or the customer's moving route.

The customer behavior analysis device 100 includes a distance image analysis unit 111, a customer recognition unit 120, a flow analysis unit 130, an action profile generation unit 140, an action information analysis unit 150, an analysis result presentation unit 160, a product information DB (database) 170, a customer information DB 180, and an action profile storage unit 190. Note that, although those blocks are described as the functions of the customer behavior analysis device 100 in this example, another configuration may be used as long as the operation according to this exemplary embodiment, which is described later, can be achieved.

Each element in the customer behavior analysis device 100 may be formed by hardware or software or both of them, and may be formed by one hardware or software or a plurality of hardware or software. For example, the product information DB 170, the customer information DB 180, and the action profile storage unit 190 may be storage devices connected to an external network (cloud). Further, the action information analysis unit 150 and the analysis result presentation unit 160 may be an analysis device different from the customer behavior analysis device 100.

Each function (each processing) of the customer behavior analysis device 100 may be implemented by a computer including CPU, memory and the like. For example, a customer behavior analysis program for performing a customer behavior analysis method (customer behavior analysis process) according to the exemplary embodiments may be stored in a storage device, and each function may be implemented by executing the customer behavior analysis program stored in the storage device on the CPU.

This customer behavior analysis program can be stored and provided to the computer using any type of non-transitory computer readable medium. The non-transitory computer readable medium includes any type of tangible storage medium. Examples of the non-transitory computer readable medium include magnetic storage media (such as floppy disks, magnetic tapes, hard disk drives, etc.), optical magnetic storage media (e.g. magneto-optical disks), CD-ROM (Read Only Memory), CD-R, CD-R/W, and semiconductor memories (such as mask ROM, PROM (Programmable ROM), EPROM (Erasable PROM), flash ROM, RAM (Random Access Memory), etc.). The program may be provided to a computer using any type of transitory computer readable medium. Examples of the transitory computer readable medium include electric signals, optical signals, and electromagnetic waves. The transitory computer readable medium can provide the program to a computer via a wired communication line such as an electric wire or optical fiber or a wireless communication line.

The distance image analysis unit 110 acquires a distance image generated by the 3D camera 210, tracks a detection target based on the acquired distance image, and recognizes its action. In this exemplary embodiment, the distance image analysis unit 110 mainly tracks and recognizes a customer's hand, a customer's line of sight, and a product picked up by a customer. The distance image analysis unit 110 refers to the product information DB 170 to recognize a product contained in the distance image. Further, a microphone may be mounted on a 3D camera, and a customer's voice input to the microphone may be recognized by a voice recognition unit. For example, based on the recognized voice, the feature (the loudness, pitch, tempo etc. of a voice) of a customer's conversation may be extracted to detect the emotion of a speaker or the excitement of the conversation, and the feature of the conversation may be recorded as an action profile.

The customer recognition unit 120 acquires a facial image of a customer generated by the facial recognition camera 220 and recognizes a customer contained in the acquired facial image by referring to the customer information DB 180. Further, the customer recognition unit 120 may recognize a customer's facial expression (pleasure, surprise etc.) from the facial image and record it as an action profile. The flow analysis unit 130 acquires an in-store image generated by the in-store camera 230, analyzes the moving history of a customer in the store based on the acquired in-store image and detects the traffic flow (moving route) of the customer.

The action profile generation unit 140 generates an action profile (customer behavior analysis information) for analyzing the behavior of a customer based on detection results of the distance image analysis unit 110, the customer recognition unit 120 and the flow analysis unit 130, and stores the generated action profile in the action profile storage unit 190. The action profile generation unit 140 refers to the product information DB 170 and the customer information DB 180, and generates and records information related to the fact that a customer has picked up a product analyzed by the distance image analysis unit 110, information on the customer recognized by the customer recognition unit 120, and information on the customer traffic flow analyzed by the flow analysis unit 130.

The action information analysis unit 150 refers to the action profile in the action profile storage unit 190 and analyzes the action of a customer based on the action profile. For example, the action information analysis unit 150 analyzes the action profile by focusing attention on a customer, a store, a shelf and a product, respectively, and calculates the rate, statistical data and the like of the action of the customer.

The analysis result presentation unit 160 presents (outputs) an analysis result of the action information analysis unit 150. The analysis result presentation unit 160 is, for example, a display device, and displays a customer behavior analysis result to a store staff or a person in charge of marketing (sales promotion). Based on the displayed customer behavior analysis result, the store staff or the person in charge of marketing improves the space planning in the store, advertisements and the like so as to promote sales.

The product information DB (product information storage unit) 170 stores product related information that is related to products placed in a store. The product information DB 170 stores, as the product related information, product identification information 171 and the like. The product identification information 171 is information for identifying a product (product master), and it includes the product code, product name, product type, product label image information (image) and the like.

The customer information DB (customer information storage unit) 180 stores customer related information that is related to customers who come to a store. The customer information DB 180 stores, as the customer related information, customer identification information 181, attribute information 182, preference information 183, history information 184 and the like.

The customer identification information 181 is information for identifying a customer, and it includes a customer's membership ID, name, address, birth date, facial image information (image) and the like. The attribute information 182 is information indicating the attributes of a customer, and it includes the age, gender, occupation and the like, for example.

The preference information 183 is information indicating the preferences of a customer, and it includes, for example, a hobby, a favorite food, color, music, movie and the like. The history information 184 is information about the history of a customer, and it includes, for example, a product purchase history, a store visit history, an in-store moving history, a contact history (access history) such as picking up/looking at a product and the like.

The action profile storage unit 190 stores the action profile generated by the action profile generation unit 140. The action profile is information for visualizing and analyzing the behavior of a customer. The visualization of the behavior is done to convert the behavior into data (numbers), and the action of a customer from entering to leaving a store is registered as data in the action profile. Specifically, the action profile contains visit record information 191 that records customers who visit a store, product record information 192 that records the fact that a customer touches a product on a shelf, and flow record information 193 that records a flow line of a customer going from one section to another in the store.

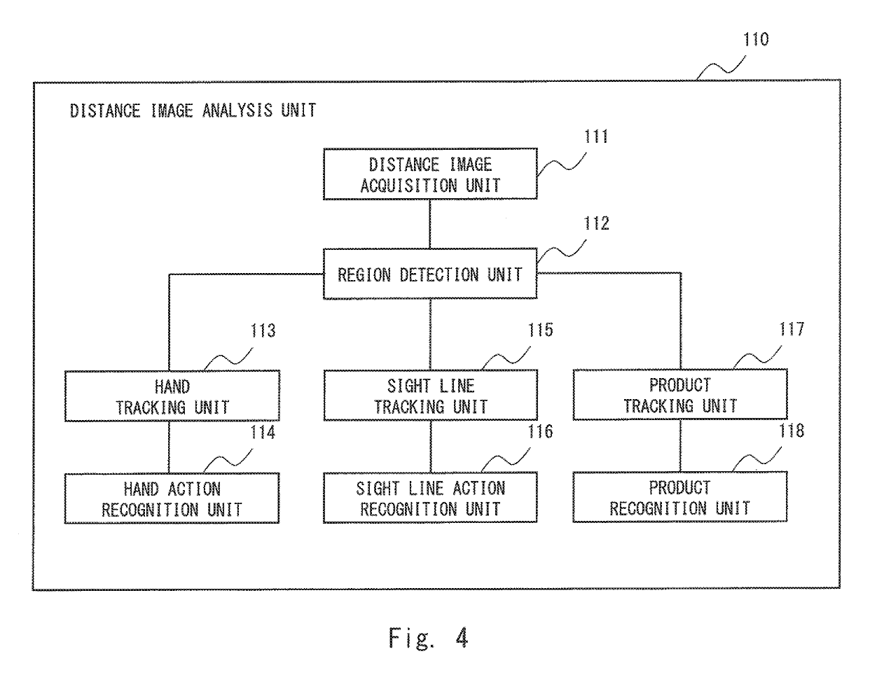

FIG. 4 shows the configuration of the distance image analysis unit 110 of the customer behavior analysis device 100. As shown in FIG. 4, the distance image analysis unit 110 includes a distance image acquisition unit 111, a region detection unit 112, a hand tracking unit 113, a hand action recognition unit 114, a sight line tracking unit 115, a sight line action recognition unit 116, a product tracking unit 117, and a product recognition unit 118.

The distance image acquisition unit 111 acquires a distance image containing a customer and a product which is taken and generated by the 3D camera 210. The region detection unit 112 detects a region of each part of a customer or a region of a product contained in the distance image acquired by the distance image acquisition unit 111.

The hand tracking unit 113 tracks the action of a customer's hand detected by the region detection unit 112. The hand action recognition unit 114 recognizes the customer's action regarding a product based on the hand action tracked by the hand tracking unit 113. For example, when a customer brings the palm of his/her hand toward his/her face while holding the product, the hand action recognition unit 114 determines that the customer has picked up and looks at the product. In the case where, when a product is held in a hand, the hand is hidden behind the product and thus not recorded by the camera, the hand action recognition unit 114 may detect the position, direction or change of the product being held and thereby determine that the customer has picked up the product.

The sight line tracking unit 115 tracks the action of the customer's line of sight (eye) detected by the region detection unit 112. The sight line action recognition unit 116 recognizes the customer's action regarding a product based on the action of the customer's line of sight (eye) detected by the sight line tracking unit 115. When a product is placed in the direction of the line of sight, the sight line action recognition unit 116 determines that the customer has looked at the product, and when the direction of the line of sight is toward a label of a product, the sight line action recognition unit 116 determines that the customer has looked at the label of the product.

The product tracking unit 117 tracks the action (state) of a product detected by the region detection unit 112. The product tracking unit 117 tracks the product which the hand action recognition unit 114 has determined that the customer has picked up or the product which the sight line action recognition unit 116 has determined that the customer has looked at. The product recognition unit 118 identifies which product corresponds to the product tracked by the product tracking unit 117 by referring to the product information DB 170. The product recognition unit 118 compares the label of the detected product with the image information on the label of the product identification information 171 stored in the product information DB 170 and performs matching to thereby recognize the product. Further, the product recognition unit 118 stores the relationship between placement positions on a shelf and products in the product information DB 170, and identifies the product based on the product picked up by the customer or the position of the shelf in which the product looked at by the customer is placed.

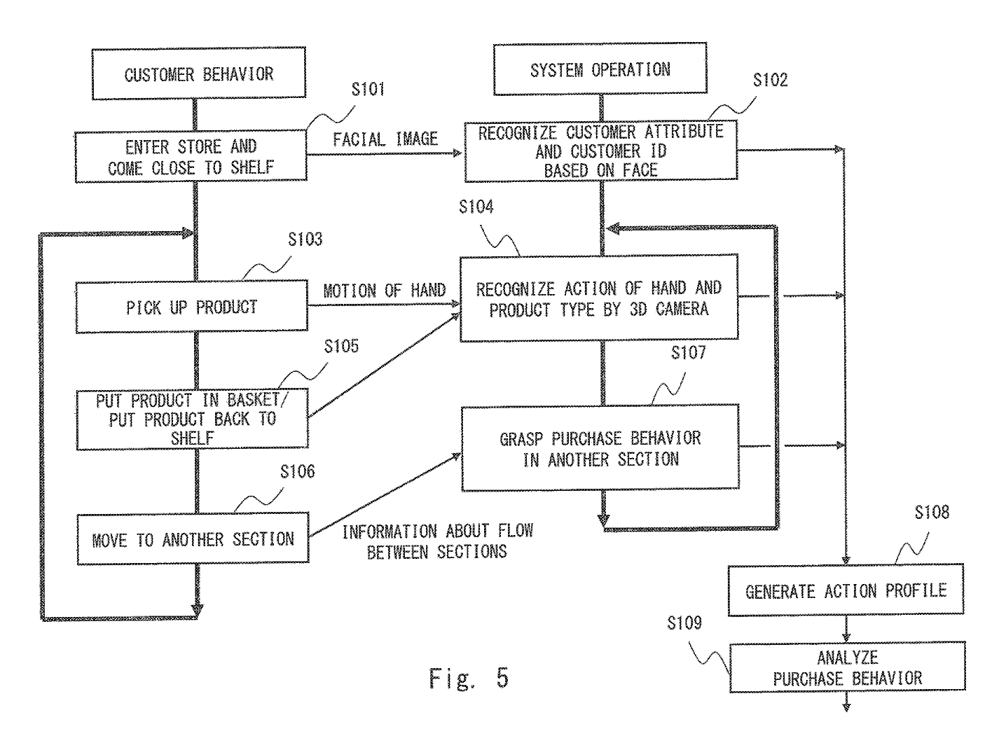

A customer behavior analysis method (customer behavior analysis process) that is performed in the customer behavior analysis system (customer behavior analysis device) according to this exemplary embodiment is described hereinafter with reference to FIG. 5.

As shown in FIG. 5, a customer enters a store and comes close to a shelf in the store (S101). Then, the facial recognition camera 220 in the store generates a facial image of the customer, and the customer behavior analysis device 100 recognizes customer attributes such as the age and gender and customer ID based on the facial image (S102). Specifically, the customer recognition unit 120 in the customer behavior analysis device 100 compares facial image information of the customer identification information 181 stored in the customer information DB 180 with the facial image taken by the facial recognition camera 220 and retrieves a customer who matches and thereby recognizes the customer, and then acquires the customer attributes and the customer ID of the recognized customer from the customer identification information 181.

After that, the customer picks up a product placed on the shelf (S103). Then, the 3D camera 210 in the vicinity of the shelf takes an image of the customer's hand, and the customer behavior analysis device 100 recognizes the action of the customer's hand and a product type by using the distance image of the 3D camera 210 (S104). Specifically, the distance image analysis unit 110 in the customer behavior analysis device 100 tracks the distance image of an image of the customer's hand (line of sight) and the product, and detects the action that the customer picks up the product (the customer looks at the product) and detects the product that matches this action by referring to the product information DB 170, and thereby recognizes the product picked up by the customer (the product looked at by the customer). Further, the distance image analysis unit 110 recognizes what part of the product the customer is looking at, particularly, whether the customer is looking at the label of the product.

Then, the customer puts the product he/she picked up in a basket or puts it back on the shelf (S105). The customer behavior analysis device 100 then recognizes the action of the customer's hand and a product type by using the distance image of the 3D camera 210 in the same manner as in the case where the customer picks up the product (S104). Specifically, the distance image analysis unit 110 in the customer behavior analysis device 100 tracks the distance image of an image of the customer's hand and the product, and detects the action that the customer puts the product in a basket or puts it back on the shelf. The product may be recognized in the same manner as in the case where the customer picks up the product, or the product recognition may be omitted because the product is already recognized.

After that, the customer moves to another section (S106). Then, the in-store camera 230 takes the image of the customer's movement between sections of the store, and the customer behavior analysis device 100 grasps the purchase behavior in another section of the store (S107). Specifically, the flow analysis unit 130 in the customer behavior analysis device 100 analyzes the customer's moving history based on the images of a plurality of sections of the store and detects the customer traffic flow and thereby grasps the purchase behavior of the customer. Then, the processing after S103 is repeated, and when the customer picks up a product in a section of the store to which he/she has moved, the customer behavior analysis device 100 detects the action of the customer.

After S102, S104 and S107, the customer behavior analysis device 100 generates an action profile based on the recognized customer information, product information, flow information and the like (S108), analyzes the generated action profile to analyze the purchase behavior, and transmits a notification or the like (S109). Specifically, the action profile generation unit 140 in the customer behavior analysis device 100 generates the action profile by associating the recognized customer information with a time or the like, associating the product which the customer picks up with a time or the like, and associating the place to which the customer has moved with a time or the like. Further, the action information analysis unit 150 calculates the rate, statistical data and the like of the customer's action in the action profile and presents a result of the analysis.

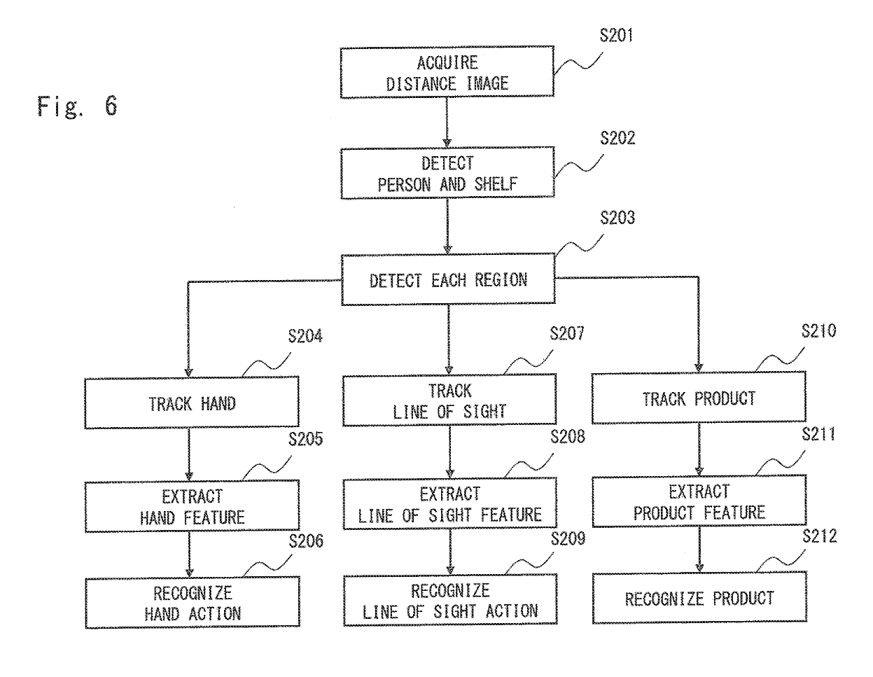

FIG. 6 shows the details of recognition processing (tracking processing) performed by the distance image analysis unit 110 in S104 of FIG. 5. Note that, the processing shown in FIG. 6 is one example of image analysis processing, and the action of a hand, the action of the line of sight, and a product may be recognized by another kind of image analysis processing.

As shown in FIG. 6, the distance image acquisition unit 111 first acquires a distance image containing a customer and a product from the 3D camera 210 (S201). Next, the region detection unit 112 detects a person and a shelf contained in the distance image acquired in S201 (S202) and further detects each region of the person and the shelf (S203). For example, the region detection unit 112 detects a person (customer) based on the image and the distance contained in the distance image by using a discrimination circuit such as SVM (Support Vector Machine), and estimates the joint of the detected person and thereby detects the bone structure of the person. The region detection unit 112 detects the region of each part such as the person's hand or face (eye) based on the detected bone structure. Further, the region detection unit 112 detects the shelf and each row of the shelf and further detects the product placement area on each shelf based on the image and the distance contained in the distance image by using the discrimination circuit.

Then, the hand tracking unit 113 tracks the action of the customer's hand detected in S203 (S204). The hand tracking unit 113 tracks the bone structure of the customer's hand and its vicinity and detects the action of the fingers or palm of the hand based on the image and the distance contained in the distance image.

After that, the hand action recognition unit 114 extracts the feature of the action of the hand based on the action of the hand tracked in S204 (S205), and recognizes the action of the customer's hand on the product, which is the action of holding the product or the action of looking at the product, based on the extracted feature (S206). The hand action recognition unit 114 extracts the direction, angle, and change in movement of the fingers or the palm (wrist) as a feature amount. For example, the hand action recognition unit 114 detects that the customer is holding the product from the angle of the fingers, and when the direction of the normal to the palm is toward the face, it detects that the customer is looking at the product. Further, the state of holding a product or the state of picking up and looking at a product may be learned in advance, and the action of the hand may be identified by comparison with the learned feature amount.

After S203, the sight line tracking unit 115 tracks the action of the customer's line of sight detected in S203 (S207). The sight line tracking unit 115 tracks the bone structure of the customer's face and its vicinity and detects the action of the face, eye and pupil based on the image and the distance contained in the distance image.

After that, the sight line action recognition unit 116 extracts the feature of the action of the line of sight based on the action of the line of sight tracked in S207 (S208), and recognizes the action of the customer's line of sight on the product, which is the action that the customer is looking at the product (label), based on the extracted feature (S209). The sight line action recognition unit 116 extracts the direction, angle, and change in movement of the face, eye and pupil as a feature amount. For example, the sight line action recognition unit 116 detects the direction of the light of sight based on the action of the face, eye and pupil and detects whether the direction of the line of sight is toward the product (label) or not. Further, the state of looking at a product may be learned in advance, the action of the line of sight may be identified by comparison with the learned feature amount.

After S203, the product tracking unit 117 tracks the action (state) of the product detected in S203 (S210). Further, the product tracking unit 117 tracks the product determined that the customer picks up in S206 and the product determined that the customer looks at in S209. The product tracking unit 117 detects the orientation, position and the like of the product based on the image and the distance contained in the distance image.

Then, the product recognition unit 118 extracts the feature of the product tracked in S210 (S211) and, based on the extracted feature, recognizes the corresponding product from the product information DB 170 (S212). The product recognition unit 118 extracts the letters or image of the label on the product as a feature amount. For example, the product recognition unit 118 compares the extracted feature amount of the label with the feature amount of the label in the product information DB 170 and identifies the product where the feature amount matches or the two features amounts are approximate (similar). Further, in the case where the relationship between placement positions on the shelf and products is stored in the product information DB 170, the position on the shelf of the product which the customer picks up or looks at is acquired based on the image and the distance contained in the distance image, and the position of the shelf is retrieved from the product information DB 170 to thereby detect the matching product.

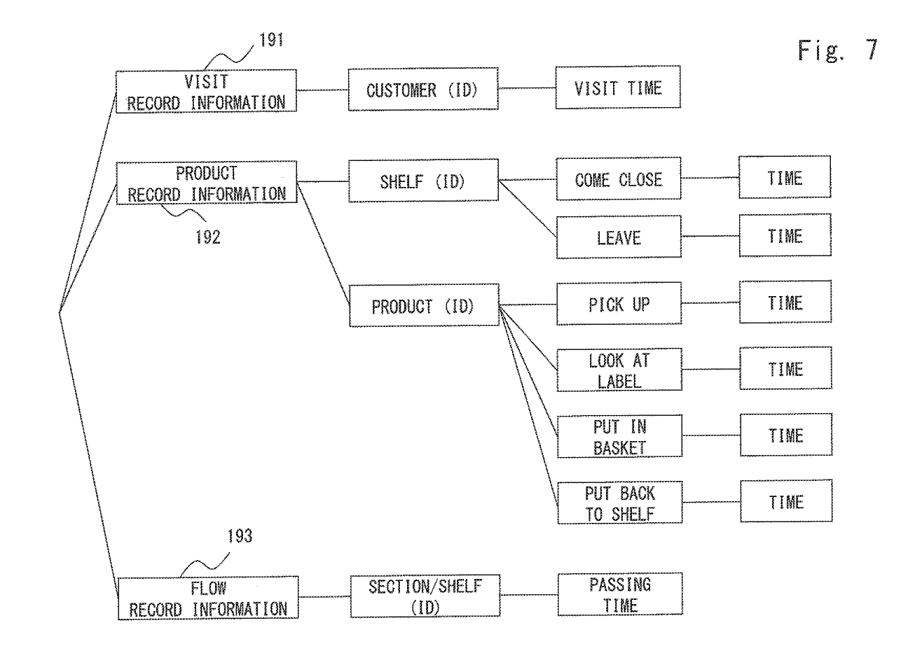

FIG. 7 shows one example of the action profile generated by the action profile generation unit 140 in S108 of FIG. 5.

When a customer comes to a store, and the customer recognition unit 120 recognizes the customer based on the facial image by the facial recognition camera 220 (S102 in FIG. 5), the action profile generation unit 140 generates and records the visit record information 191 as shown in FIG. 7 as the action profile. For example, as the visit record information 191, a customer ID that identifies the recognized customer is recorded, and the customer ID and a visit time are recorded in association with each other.

Further, when the customer comes close to a shelf, and the distance image analysis unit 110 recognizes the action of the customer that picks up a product, puts a product in a basket or puts a product back to the shelf (S104 in FIG. 5), the action profile generation unit 140 generates and records the product record information (product contact information) 192 as shown in FIG. 7 as the action profile.

For example, as the product record information 192, a shelf ID that identifies the recognized shelf is recorded, and the action of the customer that comes close to the shelf and the time when the customer comes close to the shelf are recorded in association with each other. Likewise, the action of the customer that leaves the shelf and the time when the customer leaves the shelf are recorded in association with each other.

Further, a product ID that identifies a product recognized that the customer picks up is recorded, and the product and the recognized action are recorded in association with each other. When it is recognized that the customer picks up a product, the product ID, the action that picks up the product, and the time when the customer picks up the product are recorded in association with one another. When it is recognized that the customer looks at a label of a product (picks up a product and looks at its label), the product ID, the action that looks at the label, and the time when the customer looks at the label are recorded in association with one another. When it is recognized that the customer puts a product in a basket (a shopping cart or a shopping basket), the product ID, the action that puts the product in a basket, and the time when the customer puts the product in a basket are recorded in association with one another. When it is recognized that the customer puts a product back to the shelf, the product ID, the action that puts the product back to the shelf, and the time when the customer puts the product back to the shelf are recorded in association with one another. By detecting the fact that the customer puts a product in a basket, for example, it is possible to grasp the fact that the customer purchases the product (purchase result). Further, by detecting the fact that the customer puts a product back to the shelf, it is possible to grasp the fact that the customer does not purchase the product (purchase result).

Further, when the customer moves, and the flow analysis unit 130 analyzes the customer traffic flow based on the in-store image by the in-store camera 230 (S107 in FIG. 5), the action profile generation unit 140 generates the flow record information 193 as shown in FIG. 7 as the action profile. For example, as the flow record information 193, a section (or shelf) ID that identifies a section (or shelf) which the recognized customer passes through is recorded, and the section (or shelf) ID and the time when the customer passes through the section (or shelf) are recorded in association with one another.

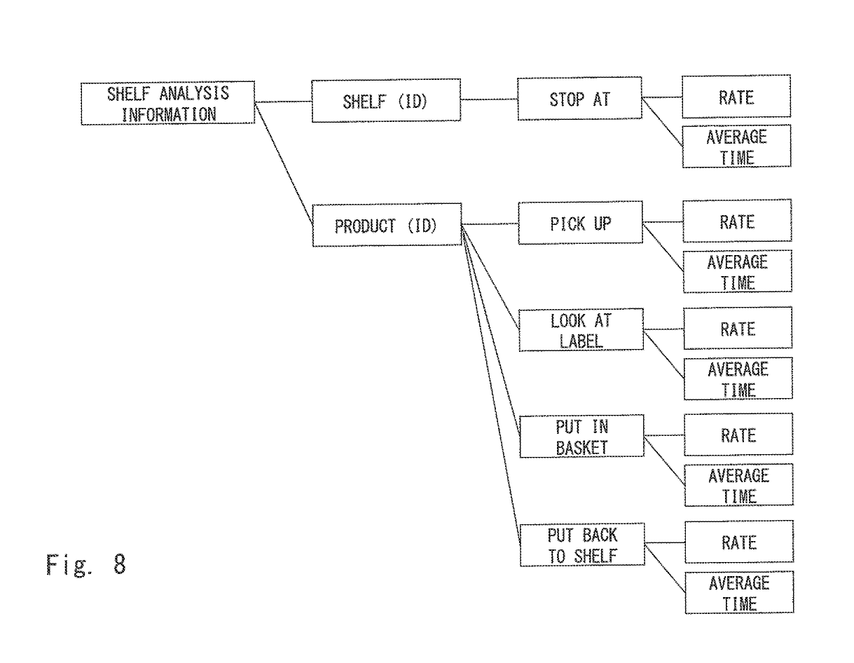

FIG. 8 shows one example of an analysis result of the action profile by the action information analysis unit 150 in S109 of FIG. 5. As shown in FIG. 8, the action information analysis unit 150 analyzes the action profile of FIG. 7 and generates shelf analysis information that analyzes statistic information for each shelf, for example.

The action information analysis unit 150 summarizes the product record information 192 related to all customers in the action profile and generates, for each shelf ID that identifies a shelf, the rate and the average time that the customer stops at the shelf.

Further, for each product ID that identifies a product placed on a shelf, the action information analysis unit 150 generates the rate and the average time that the customer picks up the product (the time that the customer is holding the product), the rate and the average time that the customer looks at the label of the product (the time that the customer is looking at the product label), the rate and the average time that the customer puts the product in a basket (the time from looking at the product to putting it in a basket), and the rate and the average time that the customer puts the product back to the shelf (the time from looking at the product to putting it back to the shelf).

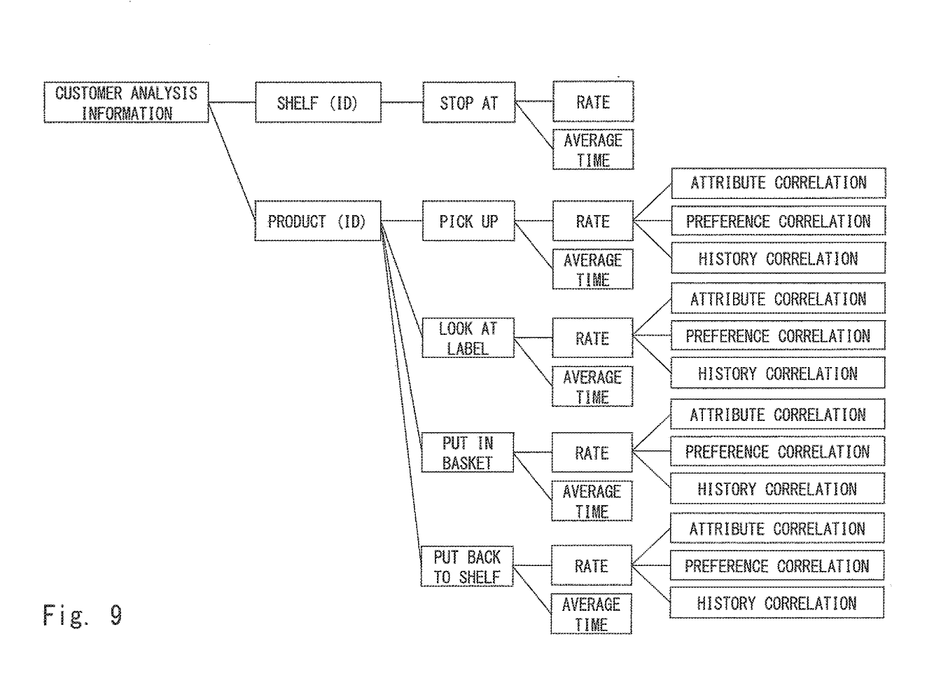

FIG. 9 shows another example of an analysis result of the action profile by the action information analysis unit 150 in S109 of FIG. 5. As shown in FIG. 9, the action information analysis unit 150 analyzes the action profile of FIG. 7 and generates customer analysis information that analyzes statistic information for each customer, for example.

The action information analysis unit 150 summarizes the visit record information 191 and the product record information 192 of the action profile for each of customers. For example, for each of customers, the rate and the average time that the customer stops at the shelf for each shelf ID, and the rate and the average time that the customer picks up the product, the rate and the average time that the customer looks at the label, the rate and the average time that the customer puts the product in a basket, and the rate and the average time that the customer puts the product back to the shelf for each product ID are generated in the same manner as in FIG. 8.

Further, the action information analysis unit 150 compares the action profile with the preference information of a customer and analyzes the correlation (relevance) between them. Specifically, it determines whether the action on each product in the action profile matches the preference of the customer. For example, when the customer picks up a favorite product or purchases it (puts it in a basket), they are determined to match (to correlate), and when the customer does not purchase a favorite product (puts it back to the shelf), they are determined not to match (not to correlate). Based on the fact that the customer's action and the customer's preference do not match, it is possible to analyze the reason that the customer has decided not to purchase the product. For example, when the customer does not purchase a favorite product after looking at its label, it is estimated that there is a problem in the way the label is displayed or the like. Further, when the customer does not pick up a favorite product and shows no interest in it, it is estimated that there is a problem in the way the product is placed or the like.

In the example of FIG. 9, the correlation with the attribute information 182 in the customer information DB 180, the correlation with the preference information 183 in the customer information DB 180, and the correlation with the history information 184 in the customer information DB 180 are determined for each of the action that picks up a product, the action that looks at a label, the action that puts a product in a basket, and the action that puts a product back to the shelf.

As described above, in this exemplary embodiment, the customer's hand motion is observed by the 3D camera placed at the potion from which a product shelf and a client (shopper) in front of the shelf can view to recognize which product the customer picks up. Then, the position (the position of the product shelf and the position in the shelf) and the time at which the product is picked up and information that identifies the product such as a product ID are recorded and analyzed, and the analysis result is displayed or notified.

It is thereby possible to detect and analyze (visualize) the action of a customer on a product in detail, and it is possible to utilize the customer's behavior before purchase to improve the sales system such as placement of products and advertisements so as to increase the sales. Specific advantageous effects are as follows.

For example, because it is possible to find out a shelf and a row in the shelf where a product is often touched by customers, it is possible to improve the product placement (space planning) by using this information. Because it is possible to find out a depth in a shelf where a customer picks up a product, it is possible to determine that restock is necessary when the customer picks up a product from the back of the shelf.

Further, the effects of leaflets or advertisements can be measured and notified by comparing the frequency of picking up a product before and after they are placed. Furthermore, pre-purchase process information from when a customer comes in front of a product to when the customer decides to purchase the product (a part on a product the customer looks at before deciding to/deciding not to purchase the product, the time the customer looks at a product/thinks about purchase before putting a product in a basket, a part of vegetable or the like the customer looks at for comparison etc.) can be notified or sold to the manufacturer of the product.

Further, it is possible to record the fact that a customer picks up a product and puts it back to a place different from the original place and notify it to employees so that they can put it back to the right position. In addition, it is possible to visualize store staff's work (inspection, restock etc.) so as to reliably perform work and eliminate redundant work. For example, it is possible to correct wrong placement or inefficient placement of products on a product shelf, or improve the cooperation of a plurality of employers such as store staff's redundant work or overlapping inspection work.

Further, by utilizing the behavior tracking between sections or stores, it is possible to improve the action at the time of purchase and the flow between sections. For example, it is possible to analyze the reason that a product is purchased in a store B rather than in a store A.

Further, it is possible to recognize whether topping work in a box lunch deli, a Chinese noodle restaurant, an ice cream shop and the like is done as ordered or not, and when it is done incorrectly, let an employee know.

### Second Exemplary Embodiment

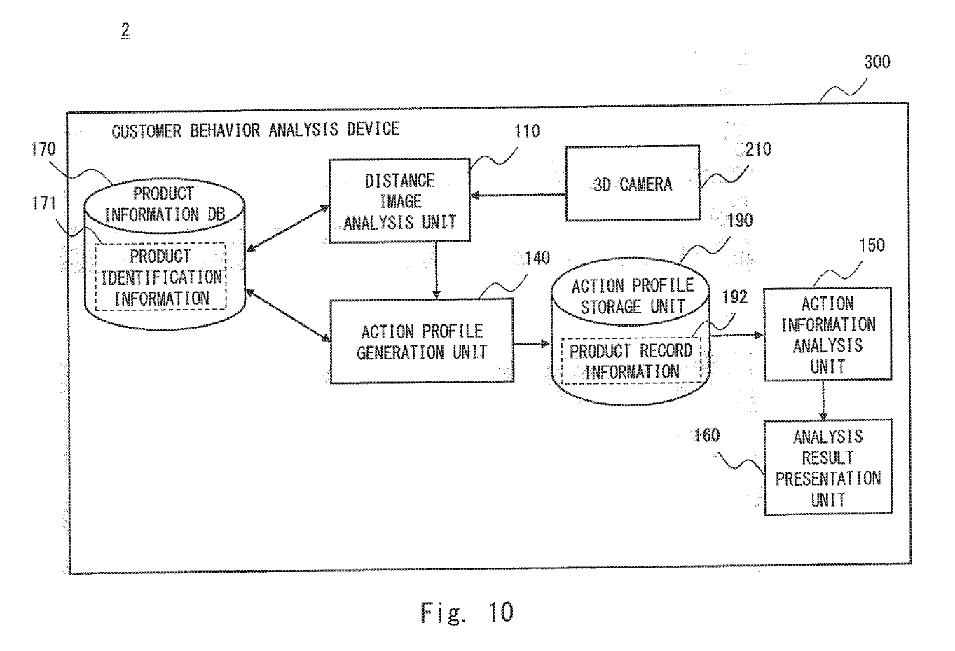

A second exemplary embodiment is described hereinafter with reference to the drawings. In this exemplary embodiment, an example where the first exemplary embodiment is applied to one shelf system is described. FIG. 10 shows the configuration of a shelf system according to this exemplary embodiment.

As shown in FIG. 8, a shelf system 2 according to this exemplary embodiment includes a product shelf 300. The product shelf 300 is a shelf where a product 301 is placed as in FIG. 3. In this exemplary embodiment, the product shelf 300 includes the 3D camera 210, the distance image analysis unit 110, the action profile generation unit 140, the action information analysis unit 150, the analysis result presentation unit 160, the product information DB 170, and the action profile storage unit 190, which are described in the first exemplary embodiment. Note that the facial recognition camera 220, the customer recognition unit 120 and the customer information DB 180 may be further included according to need.

The action profile for analyzing an action of a customer is generated based on detection results of the action profile generation unit 140 and the distance image analysis unit 110. The action profile contains the product record information 192 that records the fact that a customer touches a product on a shelf.

Specifically, in this exemplary embodiment, when a customer comes close to the shelf system 2 and picks up a product, the distance image analysis unit 110 in the shelf system 2 recognizes the customer's hand action, and the action profile generation unit 140 generates and records the product record information 192 (which is the same as in FIG. 7) as the action profile. Further, the action information analysis unit 150 analyzes the action profile and thereby generates shelf analysis information that analyzes statistic information for the shelf system (which is the same as in FIG. 8).

As described above, in this exemplary embodiment, the main elements in the first exemplary embodiment are included in one product shelf. It is thereby possible to detect the detailed action of a customer on a product and analyze the customer's action.

Further, because this exemplary embodiment can be implemented with one product shelf only, a device or a system other than the shelf is not required. It is thus possible to easily introduce this system even in a store where there is no advanced system such as a POS system or a network.

It should be noted that the present invention is not limited to the above-described exemplary embodiment and may be varied in many ways within the scope of the present invention.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese patent application No. 2013-185131, filed on Sep. 6, 2013, the disclosure of which is incorporated herein in its entirety by reference.

### REFERENCE SIGNS LIST

1 CUSTOMER BEHAVIOR ANALYSIS SYSTEM
2 SHELF SYSTEM
1 CUSTOMER BEHAVIOR ANALYSIS SYSTEM
11 IMAGE INFORMATION ACQUISITION UNIT
12 ACTION DETECTION UNIT
13 CUSTOMER BEHAVIOR ANALYSIS INFORMATION GENERATION UNIT
100 CUSTOMER BEHAVIOR ANALYSIS DEVICE
110 DISTANCE IMAGE ANALYSIS UNIT
111 DISTANCE IMAGE ACQUISITION UNIT
112 REGION DETECTION UNIT
113 HAND TRACKING UNIT
114 HAND ACTION RECOGNITION UNIT
115 SIGHT LINE TRACKING UNIT
116 SIGHT LINE ACTION RECOGNITION UNIT
117 PRODUCT TRACKING UNIT
118 PRODUCT RECOGNITION UNIT
120 CUSTOMER RECOGNITION UNIT
130 FLOW ANALYSIS UNIT
140 ACTION PROFILE GENERATION UNIT
150 ACTION INFORMATION ANALYSIS UNIT
160 ANALYSIS RESULT PRESENTATION UNIT
170 PRODUCT INFORMATION DB
171 PRODUCT IDENTIFICATION INFORMATION
180 CUSTOMER INFORMATION DB
181 CUSTOMER IDENTIFICATION INFORMATION
182 ATTRIBUTE INFORMATION
183 PREFERENCE INFORMATION
184 HISTORY INFORMATION
190 ACTION PROFILE STORAGE UNIT
191 VISIT RECORD INFORMATION
192 PRODUCT RECORD INFORMATION
193 FLOW RECORD INFORMATION
210 3D CAMERA
220 FACIAL RECOGNITION CAMERA
230 IN-STORE CAMERA
300 PRODUCT SHELF
301 PRODUCT
400 CUSTOMER

1. A customer behavior analysis system comprising:
an image information acquisition unit that acquires input image information on an image taken of a presentation area where a product is presented to a customer;
an action detection unit that detects whether the customer is holding the product and looking at an identification display of the product based on the input image information; and
a customer behavior analysis information generation unit that generates customer behavior analysis information containing a relationship between a result of the detection and a purchase result of the product by the customer.

2. The customer behavior analysis system according to claim 1, wherein the input image information is distance image information containing image information on an image of a target taken and distance information on a distance to the target measured.

3. The customer behavior analysis system according to claim 1, wherein the action detection unit tracks an action of a hand of the customer, and when the hand of the customer touches the product, determines that the customer is holding the product.

4. The customer behavior analysis system according to claim 1, wherein the action detection units tracks an action of a line of sight of the customer, and when the line of sight of the customer is toward the identification display of the product, determines that the customer is looking at the product.

5. The customer behavior analysis system according to claim 1, wherein the identification display of the product is a label containing characteristics information on the product.

6. The customer behavior analysis system according to claim 1, comprising:
a customer recognition unit that recognizes the customer, wherein
the customer behavior analysis information generation units generates information about the recognized customer as the customer behavior analysis information.

7. The customer behavior analysis system according to claim 1, comprising:
a flow analysis unit that recognizes a traffic flow of the customer, wherein
the customer behavior analysis information generation unit generates information about the analyzed flow of the customer as the customer behavior analysis information.

8. The customer behavior analysis system according to claim 1, wherein the purchase result of the product contains whether the customer has put the product in a shopping cart or a shopping basket.

9. The customer behavior analysis system according to claim 1, wherein the purchase result of the product contains whether the customer has put the product back to a placement position of the product.

10. The customer behavior analysis system according to claim 1, comprising:
a customer behavior analysis unit that recognizes behavior of the customer based on the generated customer behavior analysis information.

11. The customer behavior analysis system according to claim 10, wherein the customer behavior analysis unit calculates a rate at which the customer has looked at the identification display of the product and a rate at which the customer has purchased the product.

12. The customer behavior analysis system according to claim 10, comprising:
a customer preference information storage unit that stores preference information on the customer, wherein
the customer behavior analysis unit determines a correlation between the customer behavior analysis information and the preference information on the customer.

13. The customer behavior analysis system according to claim 10, comprising:
a customer attribute information storage unit that stores attribute information on the customer, wherein
the customer behavior analysis unit determines a correlation between the customer behavior analysis information and the attribute information on the customer.

14. The customer behavior analysis system according to claim 10, comprising:
a purchase history information storage unit that stores purchase history information on the customer, wherein
the customer behavior analysis unit determines a correlation between the customer behavior analysis information and the purchase history information on the customer.

15. A customer behavior analysis method comprising:
acquiring input image information on an image taken of a presentation area where a product is presented to a customer;
detecting whether the customer is holding the product and looking at an identification display of the product based on the input image information; and
generating customer behavior analysis information containing a relationship between a result of the detection and a purchase result of the product by the customer.

16. A non-transitory computer readable medium storing a customer behavior analysis program causing a computer to perform a customer behavior analysis process comprising:
acquiring input image information on an image taken of a presentation area where a product is presented to a customer;
detecting whether the customer is holding the product and looking at an identification display of the product based on the input image information; and
generating customer behavior analysis information containing a relationship between a result of the detection and a purchase result of the product by the customer.

17. A shelf system comprising:
a shelf placed to present a product to a customer;
an image information acquisition unit that acquires input image information on an image of the product and the customer taken;
an action detection unit that detects whether the customer is holding the product and looking at an identification display of the product based on the input image information; and
a customer behavior analysis information generation unit that generates customer behavior analysis information containing a relationship between a result of the detection and a purchase result of the product by the customer.

18. A customer behavior analysis system comprising:
an image information acquisition means for acquiring input image information on an image taken of a presentation area where a product is presented to a customer;
an action detection means for detecting whether the customer is holding the product and looking at an identification display of the product based on the input image information; and
a customer behavior analysis information generation means for generating customer behavior analysis information containing a relationship between a result of the detection and a purchase result of the product by the customer.

19. A shelf system comprising:
a shelf placed to present a product to a customer;
an image information acquisition means for acquiring input image information on an image of the product and the customer taken;
an action detection means for detecting whether the customer is holding the product and looking at an identification display of the product based on the input image information; and
a customer behavior analysis information generation means for generating customer behavior analysis information containing a relationship between a result of the detection and a purchase result of the product by the customer.
